(19) United States
(12) Patent Application Publication
(10) Pub. No.: US 2020/0290700 A1
(43) Pub. Date: Sep. 17, 2020

(54) MODIFIED ROAD BICYCLE ASSEMBLY

(71) Applicant: Russell George Namchek, Grand Rapids, MN (US)

(72) Inventor: Russell George Namchek, Grand Rapids, MN (US)

(21) Appl. No.: 16/352,938

(22) Filed: Mar. 14, 2019

(51) Int. Cl. B62K 25/08; B62K 25/28

(52) U.S. Cl. CPC B62K 25/08; B62K 25/28

(57) ABSTRACT

A modified road bicycle assembly for riding quickly over uneven road surfaces includes a bicycle frame with a top tube, a down tube, a head tube, and a seat tube. A saddle is removably engaged to an upper end of the seat tube. A handle bar is removably engaged to an upper end of the head tube. The bicycle frame is a road bike frame and the handle bar is a drop handle bar. A suspension fork is attached to the bicycle frame and extends downwardly from the head tube. A rear shock is attached to the top tube and extends rearwardly and downwardly from the top tube. A front tire is rotatably mounted to the suspension fork. A rear tire is rotatably mounted to the rear shock.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The field of the invention generally includes road bicycles and the like used for competitive racing.

### (2) Description of Related Art Including Information Disclosed Under 37 CFR 1.97 and 1.98

The disclosure and prior art relates to bicycle and suspension combination devices and more particularly pertains to a new bicycle and suspension combination device for allowing a bicyclist to travel over uneven roads in a faster, more comfortable fashion and than is achievable with a conventional road bicycle. Road bicycles tend to be very rigid and have very narrow, high pressure tires such that when traveling over an uneven road, such as for example cobblestones, the rider will have difficulty riding quickly due the vibrations felt through the frame of the bicycle. During multiple day competitions riders will typically be riding on long stretches of substantially smooth pavement. However, such races often include sections through areas of rough pavement or through towns having cobblestone roads. During these sections, it would be beneficial for the rider to be able to have a bicycle that is faster than an off-road bicycle while having greater comfort than typical road bikes.

### BRIEF SUMMARY OF THE INVENTION

An embodiment of the disclosure meets the needs presented above by generally comprising a bicycle frame with a top tube, a down tube, a head tube, and a seat tube. A saddle is removably engaged to an upper end of the seat tube. A handle bar is removably engaged to an upper end of the head tube. The bicycle frame is a road bike frame and the handle bar is a drop handle bar. A suspension fork is attached to the bicycle frame and extends downwardly from the head tube. A rear shock is attached to the top tube and extends rearwardly and downwardly from the top tube. A front tire is rotatably mounted to the suspension fork. A rear tire is rotatably mounted to the rear shock.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a modified road bicycle assembly according to an embodiment of the disclosure.

FIG. 2 is a left side view of an embodiment of the disclosure.

FIG. 3 is a right side view of an embodiment of the disclosure.

FIG. 4 is a rear view of an embodiment of the disclosure.

FIG. 5 is a top view of an embodiment of the disclosure.

### DETAILED DESCRIPTION OF THE INVENTION

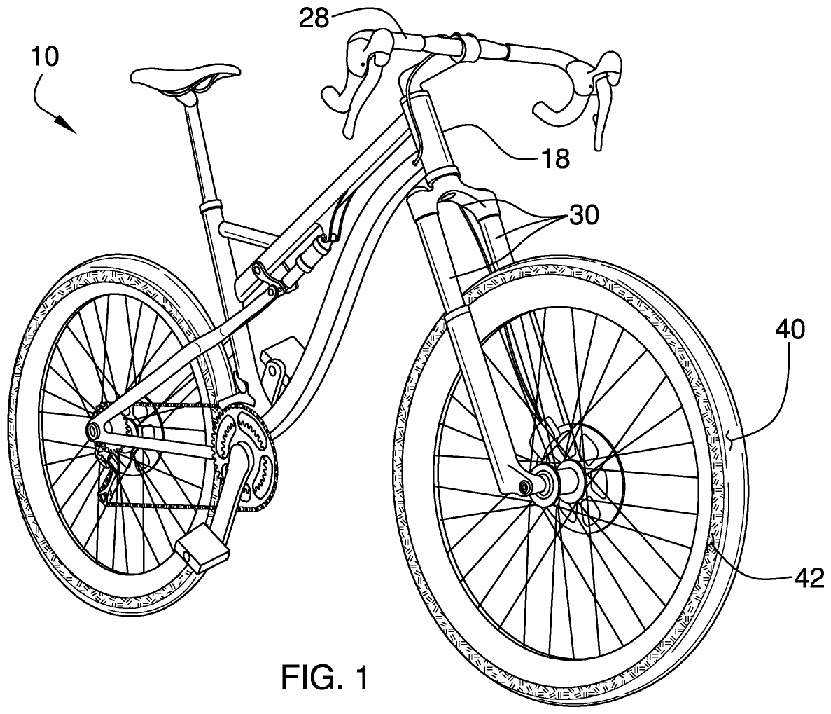

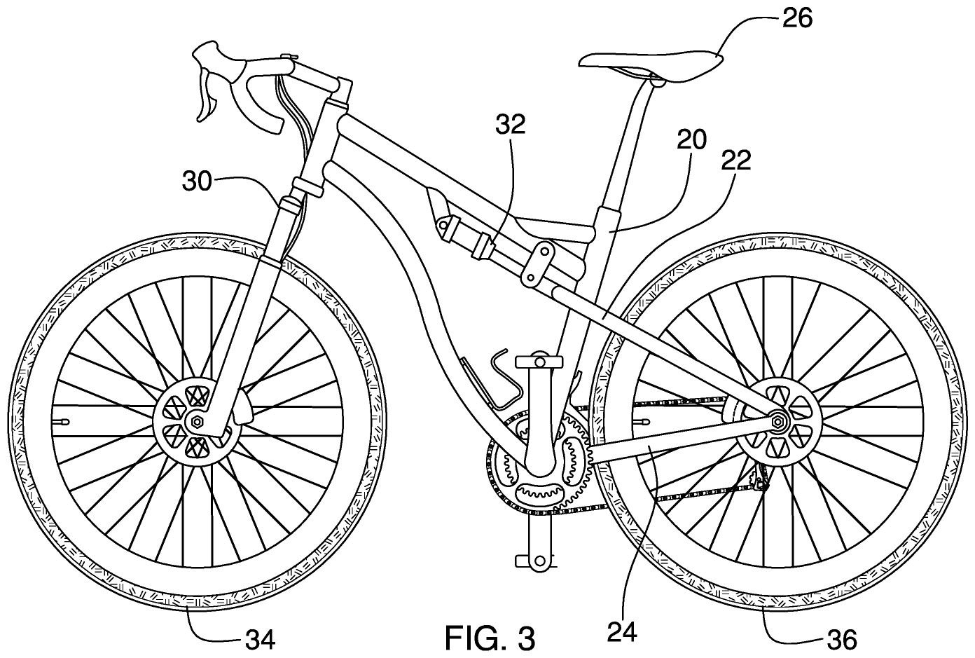

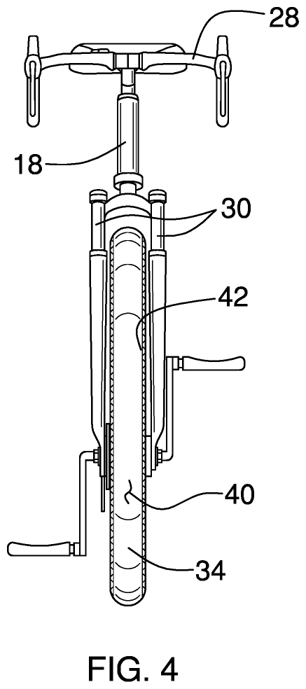

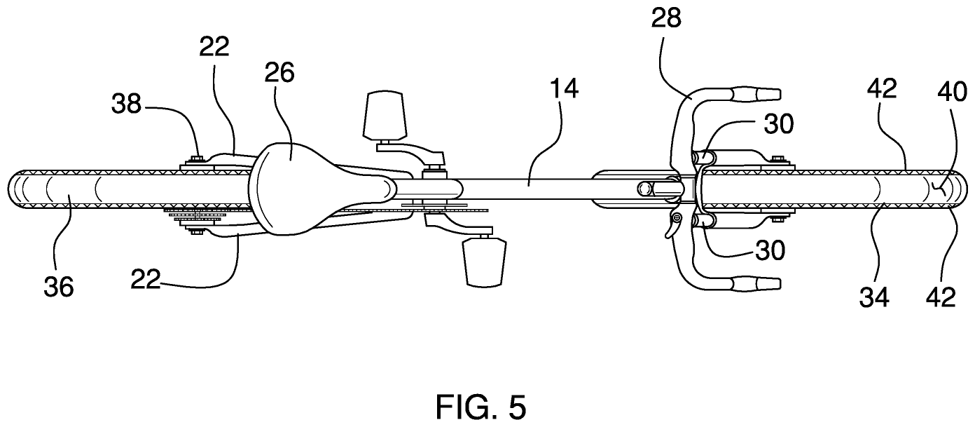

With reference now to the drawings, and in particular to FIGS. 1 through 5 thereof, a new bicycle and suspension combination device embodying the principles and concepts of an embodiment of the disclosure and generally designated by the reference numeral 10 will be described.

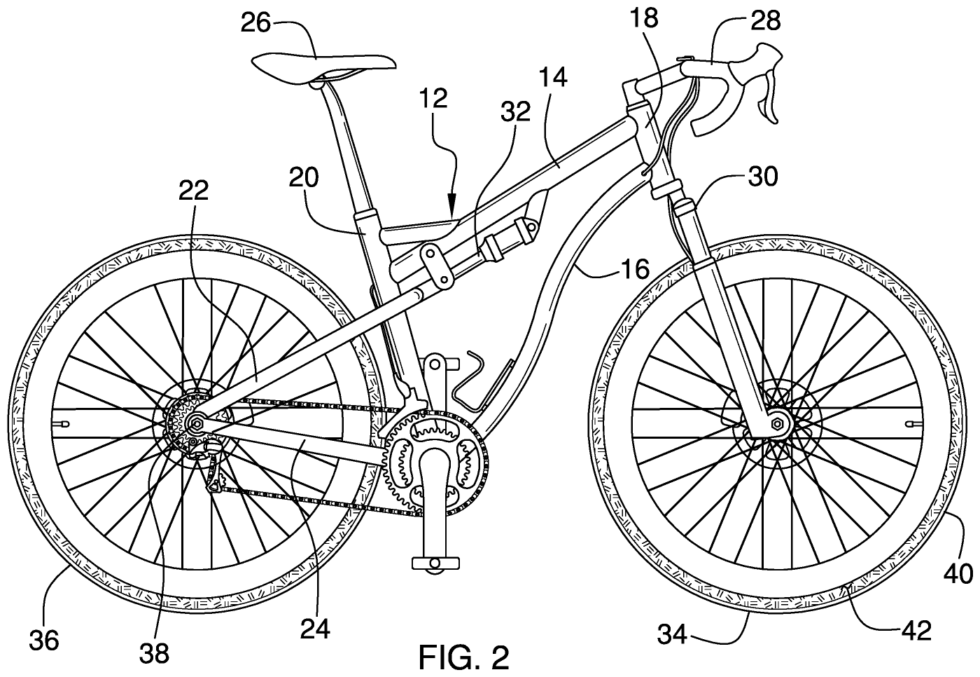

As best illustrated in FIGS. 1 through 5, the modified road bicycle assembly 10 generally comprises a generally conventional bicycle frame 12 known as road bike frame which includes, as shown best in FIG. 2, a top tube 14, a down tube 16, a head tube 18, a seat tube 20, seat stays 22 and chain stays 24. A saddle 26, or seat, is removably engaged to an upper end of the seat tube 20 and a handle bar 28 is removably engaged to an upper end of the head tube 18. The handlebar 28 will typically be a drop handle bar which allows the rider to position themselves into and remain in an aerodynamic configuration with having their head near the handlebar 28. The assembly 10 will further include typical gearing, peddling and braking systems which are commonly found on many types of bicycles.

As stated, the bicycle frame 12 is a road bike frame, sometimes known for bicycle racing, and has characteristics particular to bike frames as is known by those skilled in the art of building bicycles. Typically, a road bike frame is lightweight and has a narrow cross-section to lower the wind drag and improve the aerodynamics on the overall bicycle. This contrasts with a mountain bike frame which includes much larger components built to withstand shock and vibration while traveling over rough terrain and absorbing the forces caused by bumps in a roadway. Road bike frames are also typically taller, as measured along the seat tube, than a mountain bike for a rider of a same height. This height difference is a factor of the leg extension desired by a road bike user as well as placing the buttocks of the rider higher and promoting a body forward position on the bicycle frame. To the same point, road bike frames also have a more vertical head tube, that is a larger head tube angle, and longer length top tube compared to a mountain bike frame. The head tube of a mountain bike frame forms a lesser head tube angle with respect to a horizontal plane to push the front wheel forward and thereby give the rider more control over quick turns that are necessary while on a mountain bike. Finally, the road bike frame, compared to a mountain bike frame, has relatively smaller tube diameters and is more rigid.

Attached to the bicycle frame 12 is a conventional suspension fork 30 which extends downwardly from the head tube 18. The suspension fork 30 is attached to the handlebar 28 such that the handlebar 28 and suspension fork 30 rotate in unison with each other. The suspension fork 30 may comprise any conventional suspension fork apparatus, however, the suspension forks 30 of a mountain bike will typically have a compression travel of approximately 160mm while the one of the instant assembly 10 will preferably have less than 120mm travel and may further have less than 100mm of travel to allow for a reduction in weight of the suspension fork 30.

A rear shock 32 is attached to the top tube 14 and extends rearwardly and downwardly from the top tube 14. The rear shock 32 is also conventional and includes what would be considered the seat stays 22 which are attached to the chain stay 24.

A front tire 34 is rotatably mounted to the suspension fork 30 and a rear tire 36 is rotatably mounted to a rear axle 38 with the seat stays 22 acting as linking and extending to the rear shock 32. More specifically, the rear tire 36 is mounted at the juncture of the seat stay 22 and the chain stay 24 in a conventional manner. The front 34 and rear 36 tires are generally identical with each other and will differ from mountain bike tires in that they will be free of any lugs. Lugs, as they are commonly referred to, are the nubs which extend outwardly from the tire surface to provide for extra traction such as to dig into dirt and mud while on a mountain bike. They also resist slipping when traveling over grass or other like surfaces. However, lugs decrease the efficiency of the tire in regard to aerodynamics, rolling resistance and mechanics as a large portion of a mountain bike tire does not engage the ground surface. Thus, the front 34 and rear 36 tires are without lugs and may have a slick top tread 40. A slick top tread 40 is one bereft of any treading and is the middle surface of the tire which abuts the ground surface while the assembly 10 is being used in a straight, upright position. Alternatively, the top tread 40 may include fine, or slightly grooves, treading such as elongated troughs extending completely along the outer surfaces of the tires 34, 36. The front 34 and rear 36 tires each have a pair of lateral sides 42 which may include side wall tread which improves cornering capabilities to help prevent the tires 34, 36 from sliding laterally when the user of the assembly 10 makes tight turns at speeds in situations when the assembly 10 and rider are at least than completely vertical with respect to a riding surface.

In order to retain the speed attributes of the assembly 10, the tires 34, 36 will have size restrictions. Most road bike tires have a diameter of approximately 700 mm and the front and rear tires may have this diameter as well. The exact diameter of tires is loosely based on the width of the tire and therefore the wider the tire, the greater the diameter and circumference. Therefore, while 700 mm is considered standard, there will be slight variations expected. Unlike mountain bikes, road bikes use tires which have a narrow width. Mountain bikes have widths greater than at least 40 mm and more typically have a width greater than 50 mm or more to increase the lug surface which engages the ground to enhance traction. This increase in width requires more energy input into the tires to rotate them. Mountain bike tire diameter varies typically between 660 mm and 736 mm. Thus, the mountain bike tire has a ratio of diameter to width that is always lower than 18.40, wherein the ratio generally is much lower such as around 14. The front 34 and rear 36 tires of the current assembly 10 have a typical maximum width equal to at least 38 mm and a ratio between diameter and width being greater than 18.42. More typically, the ratio will be greater than 20.0 wherein the width of the front 34 and rear 36 tires is less than 35 mm. The width of the front 34 and rear 36 tires will typically be greater than 26 mm.

Mountain bike tires typically also have low pressurization so that they are more malleable when engaging the ground surface to again increase the surface contact area between those tires and the ground surface. Thus, mountain bike tires will typically have a pressurization of less than 35 psi. Conversely, the front 34 and rear 36 tires will have a pressurization of at least 65 psi and may preferably have a pressurization of at least 75 psi, though this pressure could be as high as 95 psi. This higher pressure and smoother tread provides a lower rolling resistance and makes for a more rigid tire that requires less energy to rotate, compared to a lugged mountain bike tire, and thereby increases the speed of the assembly 10.

In use, the assembly 10 is ridden as a conventional bicycle. However, its usage of a road bike frame 12 having added suspension features as well as tires 34, 36 that are wider and lower pressurized than typical road bike tires allows it to ride over surfaces which conventional road bikes have difficulty. In particular, these areas would include cobblestone roads as well as roads which are paved but are in disrepair. While the assembly 10 is not suited for off road biking, it will allow a racing bicyclist the ability to travel much faster over an uneven roadway where a traditional road bike is ill equipped to move quickly and comfortably compared to the assembly 10.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A bicycle assembly configured to have racing and shock absorbing characteristics, the bicycle assembly comprising:
a bicycle frame including a top tube, a down tube, a head tube, and a seat tube, a saddle being removably engaged to an upper end of the seat tube, a handle bar being removably engaged to an upper end of the head tube, the bicycle frame being a road bike frame, the handle bar being a drop handle bar;
a suspension fork being attached to the bicycle frame and extending downwardly from the head tube;
a rear shock being attached to the top tube and extending rearwardly and downwardly from the top tube;
a front tire being rotatably mounted to the suspension fork; and
a rear tire being rotatably mounted to the rear shock.

2. The bicycle assembly according to claim 1, wherein each of the front and rear tires has a ratio of diameter to width being greater than 18.4.

3. The bicycle assembly according to claim 1, wherein each of the front and rear tires having a pressurization at least equal to or greater than 65 psi.

4. The bicycle assembly according to claim 1, wherein each of the front and rear tires are free of lugs.

5. The bicycle assembly according to claim 1, wherein each of the front and rear tires having a slick top thread.

6. The bicycle assembly according to claim 5, wherein each of the front and rear tires having a side wall tread.

7. A bicycle assembly configured to have racing and shock absorbing characteristics, the bicycle assembly comprising:
a bicycle frame including a top tube, a down tube, a head tube, and a seat tube, a saddle being removably engaged to an upper end of the seat tube, a handle bar being removably engaged to an upper end of the head tube, the bicycle frame being a road bike frame, the handle bar being a drop handle bar;
a suspension fork being attached to the bicycle frame and extending downwardly from the head tube;
a rear shock being attached to the top tube and extending rearwardly and downwardly from the top tube;
a front tire being rotatably mounted to the suspension fork;
a rear tire being rotatably mounted to the rear shock;
each of the front and rear tires having a ratio of diameter to width being greater than 18.4;
each of the front and rear tires having a pressurization at least equal to or greater than 65 psi;
each of the front and rear tires being free of lugs;
each of the front and rear tires having a slick top thread; and
each of the front and rear tires having a side wall tread.
